(19) United States
(12) Patent Application Publication
(10) Pub. No.: US 2015/0138582 A1
(43) Pub. Date: May 21, 2015

(54) IMAGE FORMING APPARATUS, METHOD FOR CONTROLLING THE SAME AND STORAGE MEDIUM

(71) Applicant: CANON KABUSHIKI KAISHA, Tokyo (JP)

(72) Inventor: Yuki Ito, Kawasaki-shi (JP)

(21) Appl. No.: 14/528,184

(22) Filed: Oct. 30, 2014

(30) Foreign Application Priority Data
Nov. 15, 2013 (JP) 2013-237351

(51) Int. Cl. H04N 1/00

(52) U.S. Cl. CPC H04N 1/00925; H04N 1/00474; H04N 1/00408; H04N 1/00244; H04N 1/00206; H04N 2201/0094
USPC 358/1.13

(57) ABSTRACT

In a communication system, an image forming apparatus provides screen data for displaying a setting screen (remote UI) through which the settings of the image forming apparatus can be changed to a client PC via a network. Further, in the case where a change in the image forming apparatus is received via an operation panel (that is, via a local UI), the image forming apparatus transmits, to the client PC, data for inhibiting input related to the changed setting via the setting screen. Thereafter, when an operation of the image forming apparatus related to the changed setting is completed, the image forming apparatus transmits, to client PC, data for cancelling the inhibition of input related to the changed setting via the setting screen.

### BACKGROUND OF THE INVENTION

1. Field of the Invention

The present invention relates to an image forming apparatus whose settings can be changed via a network, a method for controlling the image forming apparatus, and a storage medium.

2. Description of the Related Art

In recent years, it has become possible, with an image forming apparatus connected to a network, to perform a functional operation and a setting change of the image forming apparatus from a client computer via the network. Therefore, there is a problem in that, while the image forming apparatus is being used by one user, the setting may be changed by another user, resulting in an unexpected operation being performed by the image forming apparatus. Japanese Patent Laid-Open No. 2007-190805 discloses a technique to be used in an image forming apparatus (multi-function peripheral) whose settings can be changed through a plurality of input paths, to inhibit a setting change through another input path while a temporary operational setting is being input into the multi-function peripheral through one of the input paths, or during an operation based on the operational setting.

In the aforementioned patent document, after a setting change is made from a client computer (client PC), it is determined whether or not the multi-function peripheral is performing an operation, or whether or not the setting screen of the multi-function peripheral is being accessed by another client PC, and the setting change is inhibited based on the determination result. However, in the case where the setting change is inhibited in this multi-function peripheral, the user is unable to recognize that the setting change has been inhibited until after having performed the operation for making the setting change. Therefore, even though the user has performed the operation for making the setting change, it was not possible to reflect the setting change in the setting of the multi-function peripheral, and the setting change is discarded, which results in the problem that the user operation to change the setting was performed for nothing.

Further, in the aforementioned multi-function peripheral, even if the inhibition of the setting change is cancelled after the user has recognized that the setting change is inhibited, the user is unable to recognize that inhibition of the setting change has been cancelled, unless the user tries to change the setting again. That is, there is a problem in that even if inhibition of the setting change is cancelled in the multi-function peripheral, the user is unable to recognize the cancellation of the inhibition immediately.

### SUMMARY OF THE INVENTION

The present invention has been devised in view of the problems described above. The present invention provides a technique which prevents an unnecessary user operation for a setting change, and enables the user to appropriately recognize the timing at which the setting change is enabled, in a communication system in which the settings of an image forming apparatus can be changed via a network.

According to one aspect of the present invention, there is provided an image forming apparatus comprising: a receiving unit configured to receive a connection request from a client computer; an operation unit configured to receive an operation by an operator, the operation being an operation for changing a setting; and a transmission unit configured to transmit, in a case where the operation is received, a notification to the client computer so as to inhibit change of the setting, and to transmit, after the change of the setting is completed, a notification to the client computer so as to permit an operation for changing the setting.

According to another aspect of the present invention, there is provided a method for controlling an image forming apparatus, comprising: receiving a connection request from a client computer; and transmitting, in a case where an operation, by an operator, for changing a setting is received, a notification to the client computer so as to inhibit change of the setting, and transmitting, after the change of the setting is completed, a notification to the client computer so as to permit an operation for changing the setting.

According to still another aspect of the present invention, there is provided a non-transitory computer-readable storage medium storing a computer program for causing a computer to execute steps of a method for controlling an image forming apparatus, comprising: receiving a connection request from a client computer; and transmitting, in a case where an operation, by an operator, for changing a setting is received, a notification to the client computer so as to inhibit change of the setting, and transmitting, after the change of the setting is completed, a notification to the client computer so as to permit an operation for changing the setting.

According to the present invention, it is possible to provide a technique which prevents an unnecessary user operation for a setting change, and enables the user to appropriately recognize the timing at which the setting change is enabled, in a communication system in which the settings of an image forming apparatus can be changed via a network.

Further features of the present invention will become apparent from the following description of exemplary embodiments (with reference to the attached drawings).

### BRIEF DESCRIPTION OF THE DRAWINGS

FIG. 1 is a view showing an example of a configuration of a communication system 100.

FIG. 2 is a block diagram showing an example of a hardware configuration of an image forming apparatus 101.

FIG. 3 is a block diagram showing an example of a hardware configuration of client PCs 102 and 103.

FIG. 4 is a block diagram showing an example of a software configuration of the image forming apparatus 101.

FIG. 5 is a block diagram showing an example of a software configuration of the client PCs 102 and 103.

FIG. 6 is a view showing an example of a transmission screen management table that is managed by a remote UI control unit 402.

FIG. 7 is a sequence diagram showing control procedures of a remote UI for changing the setting of the image forming apparatus 101 in the communication system 100 according to a first embodiment.

FIG. 8 is a flowchart showing processing procedures executed by the remote UI control unit 402 of the image forming apparatus 101 according to the first embodiment.

FIG. 9 is a flowchart showing processing procedures executed by a Web browser unit 502 of the client PC 102 according to the first embodiment and a second embodiment.

FIG. 10 is a sequence diagram showing control procedures of a remote UI for changing the setting of the image forming apparatus 101 in the communication system 100 according to the second embodiment.

FIG. 11 is a flowchart showing processing procedures executed by the remote UI control unit 402 of the image forming apparatus 101 according to the second embodiment.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

### First Embodiment

### Configuration of Communication System

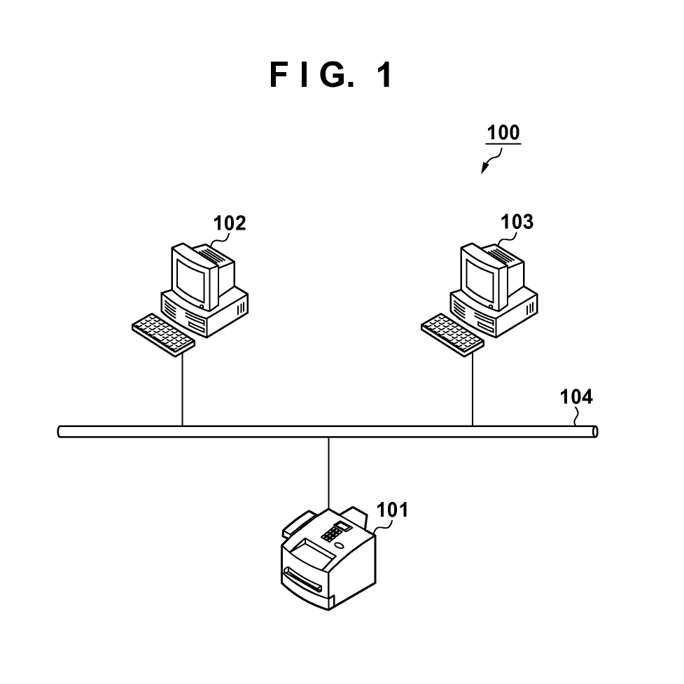

FIG. 1 is a configuration diagram showing an example of a configuration of a communication system 100 according to a first embodiment of the present invention. The communication system 100 shown in FIG. 1 includes an image forming apparatus 101, and client computers (client PCs) 102 and 103 as examples of an information processing apparatus which is communicable with the image forming apparatus. The image forming apparatus 101 is communicably connected to the client PCs 102 and 103 via a network 104. The numbers of image forming apparatuses 101 and client PCs 102 and 103 are not limited to the numbers shown in FIG. 1, and arbitrary numbers of each can exist on the network 104. Hereinafter, this embodiment will be described using the client PC 102. However, this embodiment can also be applied to the client PC 103 in the same manner.

The image forming apparatus 101 has a local user interface (local UI), and the user can change the setting of the image forming apparatus 101 using the local UI. Further, the image forming apparatus 101 provides the client PC 102, via the network 104, with screen data for displaying a setting screen through which the settings of the image forming apparatus 101 can be changed, thereby providing the client PC 102 with a remote UI. The user can change the setting of the image forming apparatus 101 via the network 104 using the remote UI of the client PC 102. The image forming apparatus 101 can change its setting according to an instruction based on the remote UI from the client PC.

Hardware Configuration of Image Forming Apparatus

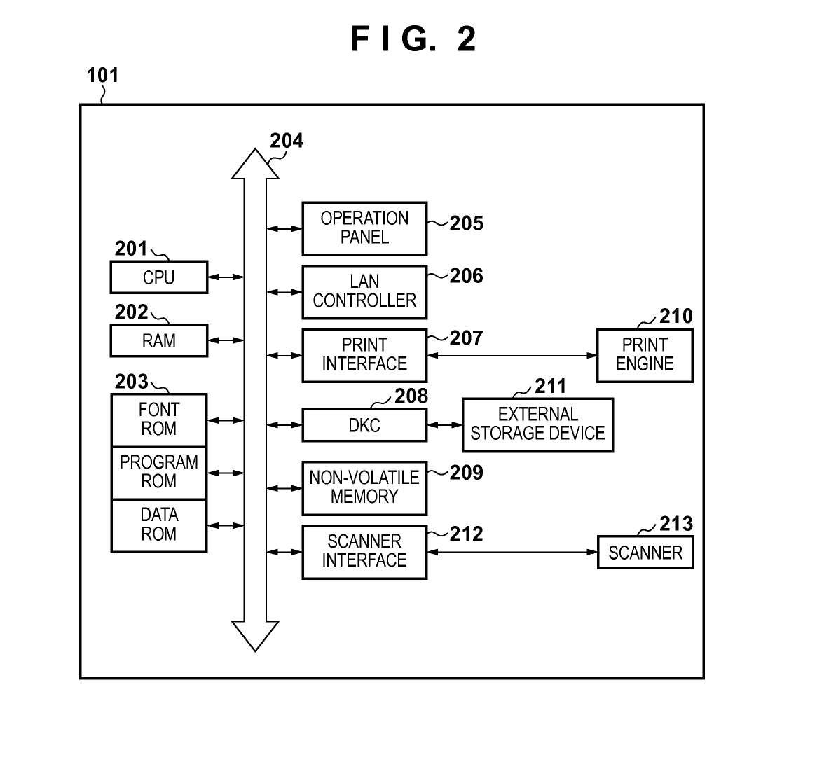

FIG. 2 is a block diagram showing an example of a hardware configuration of the image forming apparatus 101 according to this embodiment. In this embodiment, an example in which the image forming apparatus 101 is a copier is described. The image forming apparatus 101 includes a CPU 201, a RAM 202, a ROM 203, an operation panel 205, a LAN controller 206, a print interface (I/F) 207, a disk controller (DKC) 208, a non-volatile memory 209, and a scanner I/F 212, as devices connected to a system bus 204. Further, the image forming apparatus 101 further includes a print unit (print engine) 210 connected to the print I/F 207, an external storage device 211 connected to the DKC 208, and a scanner 213 connected to the scanner I/F 212.

The CPU 201 controls the operation of each device connected to the system bus 204 based on a control program stored in a program ROM of the ROM 203 or the external storage device 211. The CPU 201 outputs image signals as output information to the print engine 210 via the print I/F 207. The CPU 201 receives image signals input from the scanner 213 via the scanner I/F 212, and stores the received signals in the RAM 202 or the external storage device 211. Further, the CPU 201 can execute processing for communication with external apparatuses (such as the client PCs 102 and 103, and other image forming apparatuses) on the network 104 via the LAN controller 206.

The RAM 202 functions as a main memory, a work area, or the like, of the CPU 201 and is also used as an output information rendering area, an environment data storage area, or the like. It is possible to increase the memory capacity of the RAM 202 by connecting an optional RAM via an expansion port (not shown). The ROM 203 is constituted by a font ROM, a program ROM, and a data ROM. In the program ROM, control programs or the like which can be executed by the CPU 201 are stored. In the font ROM, font data (including outline font data) or the like to be used for generating output information to the print engine 210 is stored. In the data ROM, information or the like to be used on the client PC is stored.

The DKC 208 controls access to the external storage device 211. In this embodiment, the external storage device 211 is a hard disk drive (HDD). However, an IC card, an external memory, or the like, in which optional fonts other than the built-in font, programs for interpreting printer control languages of different language systems, or the like, are stored may be connectable to the external storage device 211.

In the HDD 211, application programs, font data, form data, and the like, are stored, and the HDD 211 is also used as a job storage area for temporarily spooling print jobs and externally controlling the spooled jobs. In the HDD 211, image data resulting from reading by the scanner 213 and image data of print jobs are further stored as BOX data. The data stored in the HDD 211 can be referred to from external apparatuses via the network 104. Further, in this embodiment, various logs such as job logs and image logs are stored in the HDD 211.

The operation panel (operation unit) 205 includes a liquid crystal panel (liquid crystal display) for displaying various information and functions, and a keyboard and a touch panel for accepting (receiving) a user operation input. Setting information indicating various settings which are set using the operation panel 205 is stored in the non-volatile memory 209.

The image forming apparatus 101 can be optionally equipped with various expansion apparatuses such as a finisher having a stapling function, a sorting function, or the like, and a duplex printing apparatus for implementing a duplex printing function. The operation of such an expansion apparatus is controlled by the CPU 201.

Hardware Configuration of Client PC

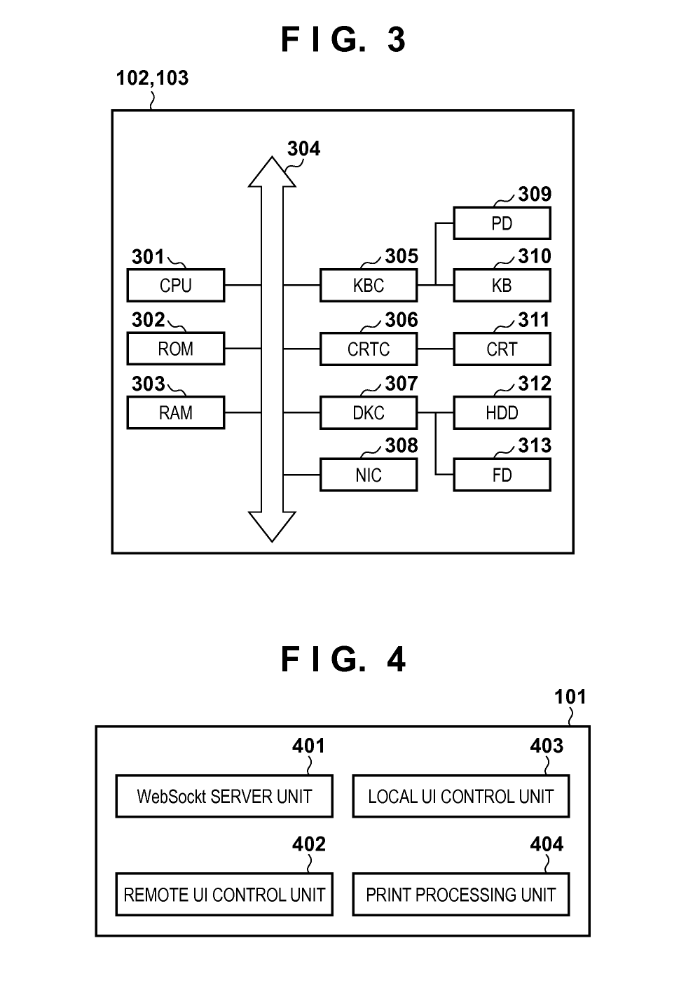

FIG. 3 is a block diagram showing an example of a hardware configuration of the client PC 102 according to this embodiment. The client PC 102 includes a CPU 301, a ROM 302, a RAM 303, a keyboard controller (KBC) 305, a display controller (CRTC) 306, a disk controller (DKC) 307, and a network interface card (NIC) 308, as devices connected to a system bus 304.

The CPU 301 controls various devices provided in the client PC 102. A BIOS and a boot program are stored in the ROM 302. The RAM 303 is used as the main storage device of the CPU 301. The KBC 305 controls input (user input) using a pointing device (PD) 309 such as a mouse and a keyboard (KB) 310. The display controller (CRTC) 306 has an internal video memory. The display controller (CRTC) 306 draws images in the video memory according to an instruction from the CPU 301, and outputs the image data drawn in the video memory as video signals to a display device (CRT) 311. In FIG. 3, a CRT is exemplified as the display unit provided in the client PC. However, other display devices such as a liquid crystal display (LCD) may be used as the display unit.

The DKC 307 controls access to an HDD 312 and a floppy (registered trademark) disk (FD) 313. An OS, various application programs operated on the OS, and the like, are stored in the HDD 312. The NIC 308 is connected to the network 104, and executes processing for communication via the network 104.

When the client PC 102 is powered on, the CPU 301 loads the OS from the HDD 312 into the RAM 303 according to the boot program stored in the ROM 302, and executes the OS. This allows the client PC 102 to function as an information processing apparatus.

Software Configuration of Image Forming Apparatus

FIG. 4 is a block diagram showing an example of a software configuration of the image forming apparatus 101. The image forming apparatus 101 includes a WebSocket server unit 401, a remote UI control unit 402, a local UI control unit 403, and print processing unit 404, as a software configuration. FIG. 4 shows only the software configuration that is particularly related to the description of this embodiment.

The image forming apparatus 101 is communicable with the client PCs 102 and 103 via a connection established by WebSocket. WebSocket is a technique for bidirectional communication which is defined by internet standards organizations, W3C and IETF. A TCP connection, instead of HTTP, is established and maintained, thereby allowing communication to be performed from either of the client and the server at an arbitrary timing.

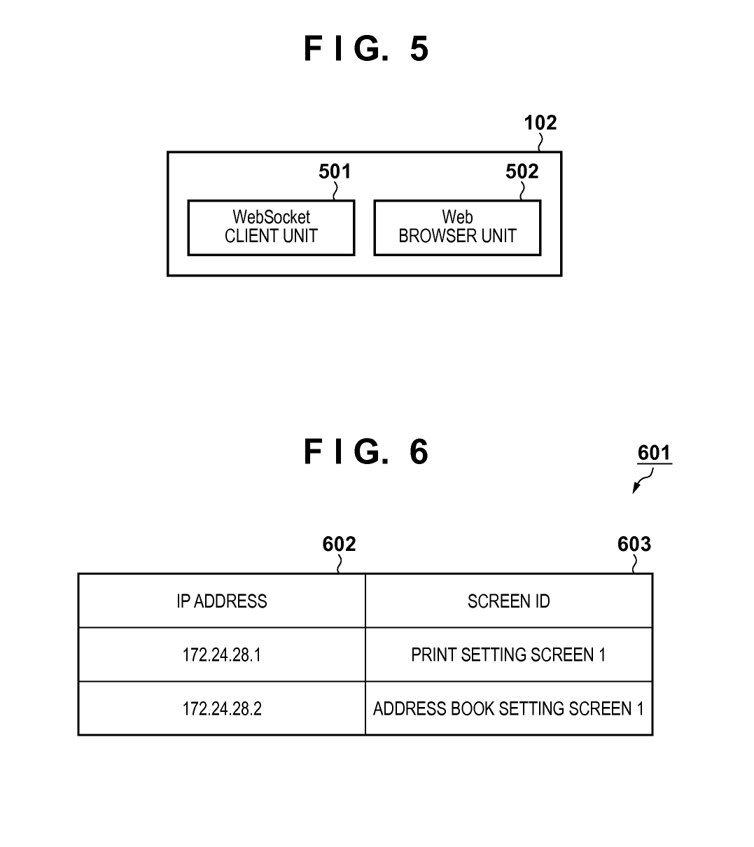

The WebSocket server unit 401 receives a WebSocket connection request from a WebSocket client unit 501 (FIG. 5) of the client PCs 102 and 103 via the network 104, and returns a response to the connection request. Further, the WebSocket server unit 401 receives a setting from the WebSocket client unit 501 through the connection established by WebSocket, and passes the received setting to the remote UI control unit 402. Upon receiving an instruction from the remote UI control unit 402, the WebSocket server unit 401 transmits data (screen data) for displaying an authentication screen or a setting screen to the WebSocket client unit 501 of the client PCs 102 and 103. The screen data of the authentication screen or the setting screen is HTML data, for example.

The remote UI control unit 402 receives a setting from the WebSocket server unit 401, and reflects the received setting in the setting of the image forming apparatus 101. Further, the remote UI control unit 402 passes the screen data for displaying the authentication screen or the setting screen to the WebSocket server unit 401, thereby transmitting the screen data to the WebSocket client unit 501 via the network 104. Thus, the screen data is provided to the client PCs 102 and 103.

The local UI control unit 403 receives, from the operation panel 205, the setting input (received) via the operation panel 205, and reflects the received setting in the setting of the image forming apparatus 101.

The print processing unit 404 analyzes a copy job or a print job received via the network 104 or generated in the image forming apparatus 101, and renders the copy job or print job into bitmap data. Further, the print processing unit 404 causes the print engine 210 to print an image onto paper based on the rendered bitmap data. When the print processing is started or completed by the print engine 210, the print processing unit 404 notifies the remote UI control unit 402 that the print processing has started or been completed.

Software Configuration of Client PC

FIG. 5 is a block diagram showing an example of a software configuration of the client PC 102. The client PC 102 includes the WebSocket client unit 501 and a Web browser unit 502 as a software configuration. FIG. 5 shows only the software configuration that is particularly related to the description of this embodiment.

The WebSocket client unit 501 transmits a WebSocket connection request to the WebSocket server unit 401 via the network 104, and receives a response to the connection request. Further, the WebSocket client unit 501 receives a setting from the Web browser unit 502, and transmits the setting to the WebSocket server unit 401 through the connection established by WebSocket. Further, the WebSocket client unit 501 receives screen data for displaying an authentication screen or a setting screen from the WebSocket server unit 401, and passes the received screen data to the Web browser unit 502.

The Web browser unit 502 receives a user input (that is, user input using the PD 309 or the KB 310) via the authentication screen or the setting screen displayed on the CRT 311, and passes the input setting to the WebSocket client unit 501. Thus, the Web browser unit 502 transmits the setting to the WebSocket server unit 401 (the image forming apparatus 101). Further, the Web browser unit 502 displays the authentication screen or the setting screen on the CRT 311 based on the screen data received from the WebSocket client unit 501 (that is, the screen data provided by the remote UI control unit 402).

Transmission Screen Management Table

FIG. 6 is an example of a transmission screen management table managed by the remote UI control unit 402 in the image forming apparatus 101. A transmission screen management table 601 contains an IP address 602, and a screen ID 603 of the screen that corresponds to the screen data transmitted last time. The transmission screen management table 601 is stored in the RAM 202 or the HDD 211 and is managed therein.

The IP address 602 is an IP address of an external apparatus such as the client PCs 102 and 103. Other than the IP address, any identification information which can identify the external apparatus may be managed instead of the IP address. The screen ID 603 is a screen ID of the screen that corresponds to the screen data transmitted last time by the remote UI control unit 402 to the device identified by the IP address 602. Every time the remote UI control unit 402 transmits screen data to the external apparatus (the client PC 102 or 103 in this embodiment), the remote UI control unit 402 stores the screen ID of the screen that corresponds to the transmitted screen data in the transmission screen management table 601. The screen ID 603 is used by the remote UI control unit 402 to determine which screen data to be transmitted next.

Summary of Remote UI Control in Communication System

In the communication system 100 of this embodiment, the image forming apparatus 101 provides the client PC 102 with screen data for displaying a setting screen through which the settings of the image forming apparatus 101 can be changed. Further, when receiving a change in the image forming apparatus 101 via the operation panel 205 (that is, via the local UI), the image forming apparatus 101 transmits, to the client PC 102, data for inhibiting input related to the changed setting via the setting screen. Thus, a setting change related to the changed setting via the remote UI is inhibited. Thereafter, when the operation of the image forming apparatus 101 related to the changed setting is completed, the image forming apparatus 101 transmits, to the client PC 102, data for cancelling the inhibition of input related to the changed setting via the setting screen. Thus, a setting change related to the changed setting via the remote UI is enabled again.

On the other hand, the client PC 102 displays a setting screen on the CRT 311, based on the screen data provided by the image forming apparatus 101. Further, the client PC 102 inhibits input via the setting screen displayed on the CRT 311, or cancels the inhibition of input, in accordance with the aforementioned data transmitted by the image forming apparatus 101.

In this way, when a setting change of the image forming apparatus 101 via the remote UI is to be inhibited, the image forming apparatus 101 controls the client PC 102 so as to inhibit the setting change via the remote UI in this embodiment. In the client PC 102, the actual user operation for making a setting change is inhibited, which enables an unnecessary user operation for making a setting change to be prevented. Further, in this embodiment, the image forming apparatus 101 controls the client PC 102 so as to cancel the inhibition of the setting change via the remote UI, when the setting change of the image forming apparatus 101 via the remote UI is enabled. In this way, the remote UI of the client PC 102 is controlled in real time according to the state of the image forming apparatus 101. Thus, the user of the client PC 102 can recognize with certainty the timing at which the setting change of the image forming apparatus 101 becomes enabled.

In the examples described below, the WebSocket server unit 401 and the remote UI control unit 402 function as an example of a provision unit and a transmission unit, and the Web browser unit 502 functions as an example of a control unit and a display control unit.

Example of Control of Remote UI in Communication System

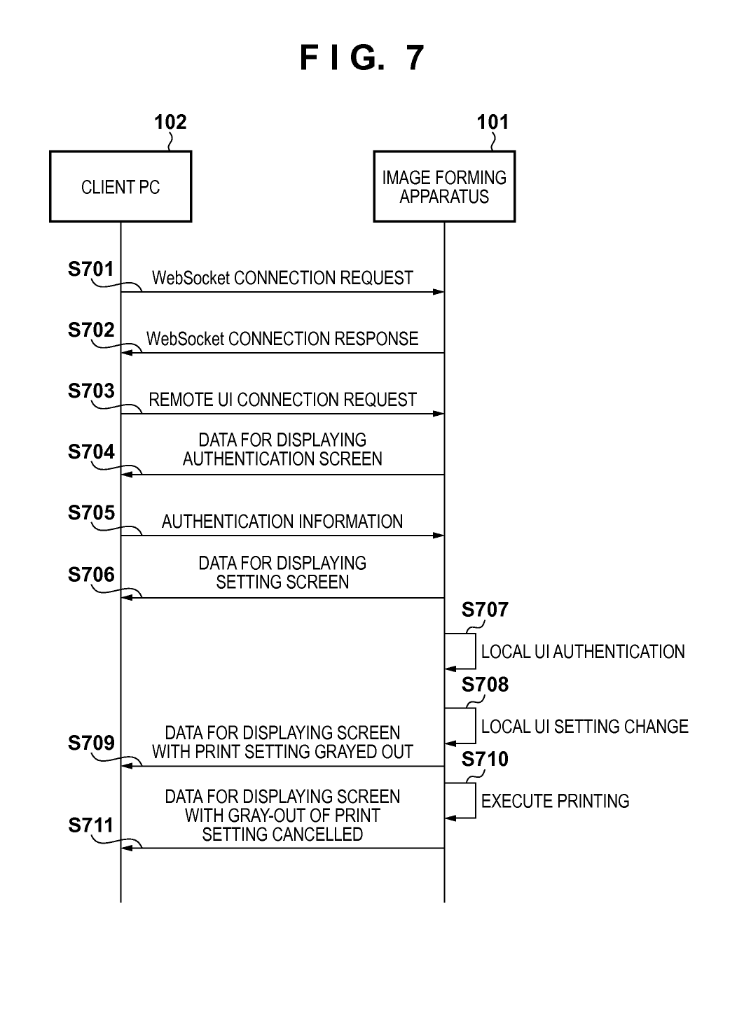

FIG. 7 is a sequence diagram showing control procedures, which are executed by the image forming apparatus 101 and the client PC 102 in the communication system 100 according to this embodiment, for controlling the remote UI used to change the setting of the image forming apparatus 101. The processing of each step shown in FIG. 7 is performed in the image forming apparatus 101 by the CPU 201 loading a control program stored in the HDD 211 into the RAM 202 and executing the loaded control program. Further, in the client PC 102, the process of each step is performed by the CPU 301 loading a control program stored in the HDD 312 into the RAM 303 and executing the loaded control program.

In step S701, the client PC 102 transmits a WebSocket connection request to the image forming apparatus 101. In step S702, the image forming apparatus 101 transmits, to the client PC 102, a WebSocket connection response to the received WebSocket connection request.

Next, in step S703, the client PC 102 makes a remote UI connection request to the image forming apparatus 101. In step S704, the image forming apparatus 101 transmits screen data for displaying an authentication screen to the client PC 102 in response to the remote UI connection request from the client PC 102. The screen data, for example, is HTML data. The client PC 102 displays the authentication screen on the CRT 311, based on the screen data received from the image forming apparatus 101.

When the user of the client PC 102 inputs authentication information via the authentication screen, the client PC 102 transmits the authentication information to the image forming apparatus 101 in step S705. When user authentication based on the authentication information that is received from the client PC 102 is successful, the image forming apparatus 101 transmits screen data for displaying a setting screen containing a print-related setting to the client PC 102 in step S706.

In step S707, upon receiving input of authentication information from the user of the image forming apparatus 101, the image forming apparatus 101 (the local UI control unit 403) performs user authentication. When the user authentication is completed, the user is enabled to change the setting of the image forming apparatus 101 via (the setting screen displayed on) the operation panel 205. Thereafter, the image forming apparatus 101 receives a setting change of the image forming apparatus 101 via the operation panel 205 in step S708. It is assumed herein that a change of a print-related setting is received from the user. A print-related setting, for example, is a setting of the number of copies, a color setting, a duplex setting, a scale setting, and the like.

Upon receiving the change of a print-related setting from the user, the image forming apparatus 101 transmits, to the client PC 102, screen data for displaying a screen on which the print-related setting is grayed out in step S709. This screen data is an example of data for inhibiting input via the setting screen in the client PC 102. The client PC 102 displays, based on the screen data, the setting screen in the state where input for the item (print-related setting) related to the changed setting is disabled.

In step S709, it is also possible to transmit a notification to gray out the print-related setting to the client PC 102, instead of the screen data for displaying the screen on which the print-related setting is grayed out. This notification corresponds to control data indicating to disable input for the item (print-related setting) related to the changed setting on the setting screen being displayed. In this case, the Web browser unit 502 of the client PC 102 that has received the notification can cause the print-related setting on the screen being displayed to be grayed out using a script language such as JavaScript (registered trademark). Further, in step S711 to be described below, a notification to cancel the gray-out of the print-related setting may be transmitted to the client PC 102. This notification corresponds to control data indicating to enable input for the item (print-related setting) related to the changed setting.

Thereafter, upon receiving input from the user indicating to execute print processing, the image forming apparatus 101 executes the print processing in step S710. When the print processing is completed, the image forming apparatus 101 transmits, to the client PC 102, screen data for displaying a screen on which the gray-out of the print-related setting is cancelled in step S711. Such screen data is an example of data for cancelling the inhibition of input via the setting screen in the client PC 102. The screen data transmitted by the image forming apparatus 101 in step S710 is the same as the screen data transmitted in step S706.

The same process as above may be executed, not only when a change to a print-related setting is received in step S708, but also when a setting value is imported or exported. In that case, when the import or export of a setting value is started (S708), the image forming apparatus 101 transmits screen data for displaying the grayed-out screen to the client PC 102 (S709). Thereafter, when the import or export of the setting value is completed (S710), the image forming apparatus 101 transmits, to the client PC 102, screen data for displaying a screen on which the gray-out is cancelled (S711).

Alternatively, the image forming apparatus 101 may transmit a notification to display a pop-up on the CRT 311 by the Web browser unit 502 of the client PC 102, instead of transmitting the screen data for displaying the grayed-out screen (S709). This notification corresponds to data for causing the display unit to display information indicating that input for the item (print-related setting) related to the changed setting is inhibited. In this case, in the client PC 102, the Web browser unit 502 that has received the notification displays a pop-up on the CRT 311 and inhibits a setting change. Thereafter, the image forming apparatus 101 transmits a notification to delete the pop-up displayed on the CRT 311 by the Web browser unit 502 of the client PC 102 (S711). This notification corresponds to data for cancelling the display of information based on the data for inhibiting the input.

Further, the image forming apparatus 101 may transmit screen data for displaying a screen in which the setting change is reflected, instead of transmitting the screen data for displaying the grayed-out screen (S709). In that case, in the client PC 102, the Web browser unit 502 displays the screen on the CRT 311 based on the received screen data. This allows the user to immediately recognize that the setting has been changed, based on the displayed screen.

Further, the image forming apparatus 101 may transmit a notification to update the screen by the Web browser unit 502 of the client PC 102, instead of transmitting the screen data for displaying the grayed-out screen. In that case, the Web browser unit 502 that has received the notification updates the screen that is being displayed on the CRT 311. This allows the user to immediately recognize that the setting has been changed. In the case where the image forming apparatus 101 transmits screen data for displaying a screen in which the setting change is reflected, or transmits a notification to update the screen, nothing needs to be transmitted to the client PC 102 in step S711.

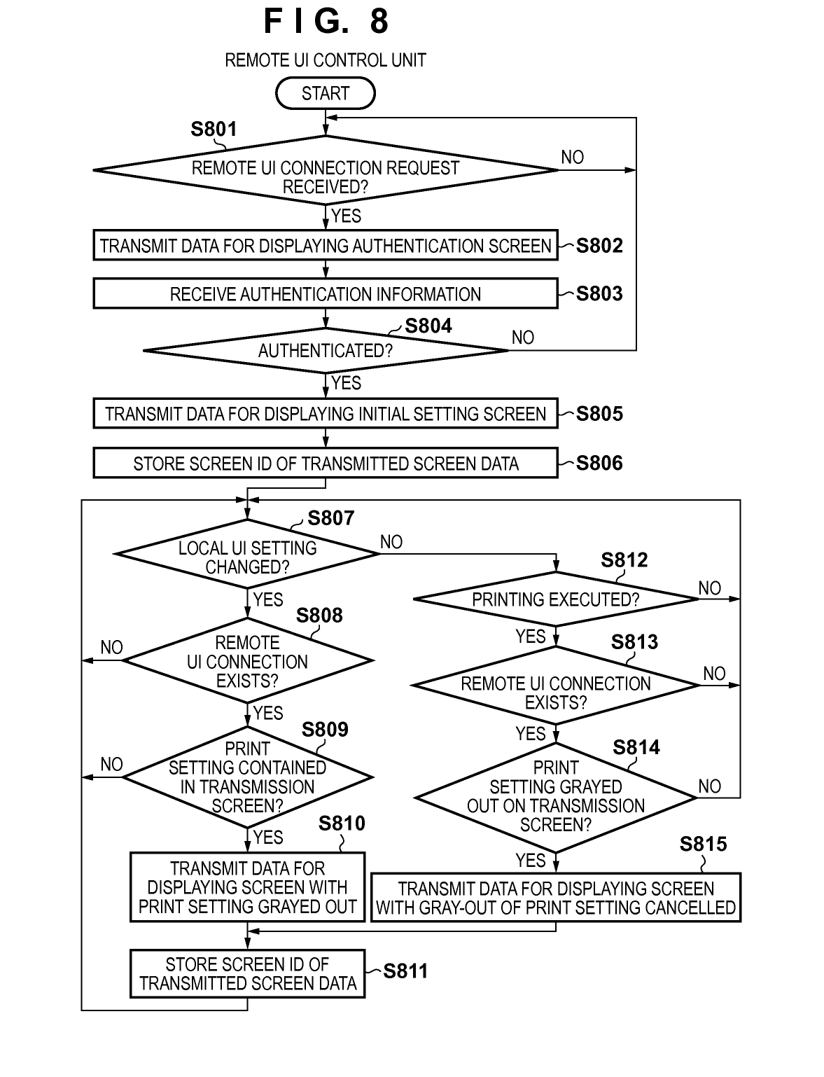

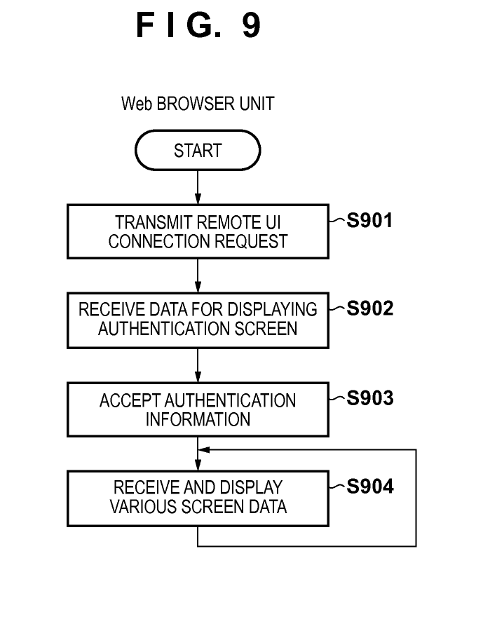

Hereinafter, processing procedures to be executed in the image forming apparatus 101 and the client PC 102, which have been described with reference to FIG. 7, will be described with reference to FIG. 8 and FIG. 9, respectively.

Example of Process in the Image Forming Apparatus 101

FIG. 8 is a flowchart showing processing procedures to be executed by the remote UI control unit 402 of the image forming apparatus 101. The process of each step shown in the figure is performed in the image forming apparatus 101 by the CPU 201 of the image forming apparatus 101 loading a program stored in the HDD 211 into the RAM 202 and executing the loaded program.

In step S801, the remote UI control unit 402 determines whether or not a remote UI connection request has been received from the client PC 102. If a request is determined to have been received, the processing proceeds to step S802. If the request is determined not to have been received, the processing returns to step S801. In step S802, the remote UI control unit 402 transmits screen data for displaying an authentication screen to the WebSocket server unit 401.

Next, upon receiving authentication information from the WebSocket server unit 401 in step S803, the remote UI control unit 402 determines whether or not the received authentication information is valid in step S804. If the received authentication information is determined to be valid by the remote UI control unit 402 in step S804, the processing proceeds to step S805. If it is determined not to be valid, the processing returns to step S801.

In step S805, the remote UI control unit 402 transmits data for displaying an initial setting screen to the client PC 102 via the WebSocket server unit 401. Further, the remote UI control unit 402 stores the screen ID of the screen data transmitted in step S805, as information indicating the screen data transmitted last time, in the transmission screen management table 601 in step S806.

Thereafter, in step S807, the remote UI control unit 402 determines whether or not the setting of the image forming apparatus 101 has been changed by the local UI control unit 403. If the setting is determined to have been changed, the processing proceeds to step S808. If the setting is determined not to have been changed, the processing proceeds to S812.

In step S808, the remote UI control unit 402 determines whether or not a remote UI connection exists. If a connection is determined to exist, the processing proceeds to step S809. If a connection is determined not to exist, the processing returns to S807. In step S809, the remote UI control unit 402 determines whether or not a print setting is contained in the setting screen based on the screen data transmitted in step S806. If the print setting is determined to be contained, the processing proceeds to step S810. If the print setting is determined not to be contained, the processing returns to step S807. In step S810, the remote UI control unit 402 transmits, to the WebSocket server unit 401 (the client PC 102), screen data for displaying a screen on which the print setting is grayed out. Further, in step S811, the remote UI control unit 402 stores the screen ID of the transmitted screen data. Thereafter, the processing returns to step S807.

On the other hand, if the setting of the image forming apparatus 101 has not been changed by the local UI control unit 403, the remote UI control unit 402 determines, in step S812, whether or not a notification indicating that print processing has been executed has been received from the print processing unit 404. Thus, the local UI control unit 403 determines whether or not print processing has been executed (whether or not execution has been completed). If the print processing is determined to have been executed, the processing proceeds to step S813. If the print processing is determined not to have been executed, the processing returns to step S807. In step S813, the remote UI control unit 402 determines whether or not a remote UI connection exists. If the remote UI connection is determined to exist, the processing proceeds to step S814. If the remote UI connection is determined not to exist, the processing returns to step S807.

In step S814, the remote UI control unit 402 determines whether or not the screen data transmitted last time is screen data for displaying a screen on which a print setting is grayed out. If the remote UI control unit 402 determines that the screen data transmitted last is screen data for displaying a screen on which a print setting is grayed out, the processing proceeds to step S815. Otherwise, the processing returns to step S807. In step S815, the remote UI control unit 402 transmits, to the WebSocket server unit 401 (the client PC 102), screen data for displaying a screen on which the gray-out of the print setting is cancelled. Thereafter, the processing proceeds to step S811.

Example of Processing in the Client PC 102

FIG. 9 is a flowchart showing processing procedures executed by the Web browser unit 502 of the client PC 102. The processing of each step shown in the figure is performed in the client PC 102 by the CPU 301 of the client PC 102 loading a program stored in the HDD 312 into the RAM 303 and executing the loaded program.

In step S901, upon receiving input from the user, the Web browser unit 502 transmits a remote UI connection request to the image forming apparatus 101 (the remote UI control unit 402) via the WebSocket client unit 501.

Next, in step S902, the Web browser unit 502 receives screen data for displaying an authentication screen from the image forming apparatus 101 via the WebSocket client unit 501, and displays the authentication screen on the CRT 311. Further, in step S903, upon accepting (receiving) input of authentication information from the user, the Web browser unit 502 transmits the received authentication information to the image forming apparatus 101 via the WebSocket client unit 501.

Thereafter, in step S904, the Web browser unit 502 displays a setting screen, on the CRT 311, based on various screen data received from the image forming apparatus 101 via the WebSocket client unit 501, and repeats the processing of step S904 until the remote UI connection is disconnected.

According to this embodiment, in the communication system 100 which allows the setting of the image forming apparatus 101 to be changed via the network 104, an unnecessary user operation for a setting change is prevented, and the user can appropriately recognize the timing at which a setting change is enabled.

### Second Embodiment

In the first embodiment, control of the remote UI was described which is performed in the case where the setting of the image forming apparatus 101 is changed via the local UI while a remote UI connection is established from the client PC 102 to the image forming apparatus 101 by WebSocket. In the second embodiment, control of the remote UI will be described which is performed in the case where execution of a function of the image forming apparatus 101 is started while the remote UI connection is established. In order to simplify the description, description of parts that are in common with the first embodiment is omitted below.

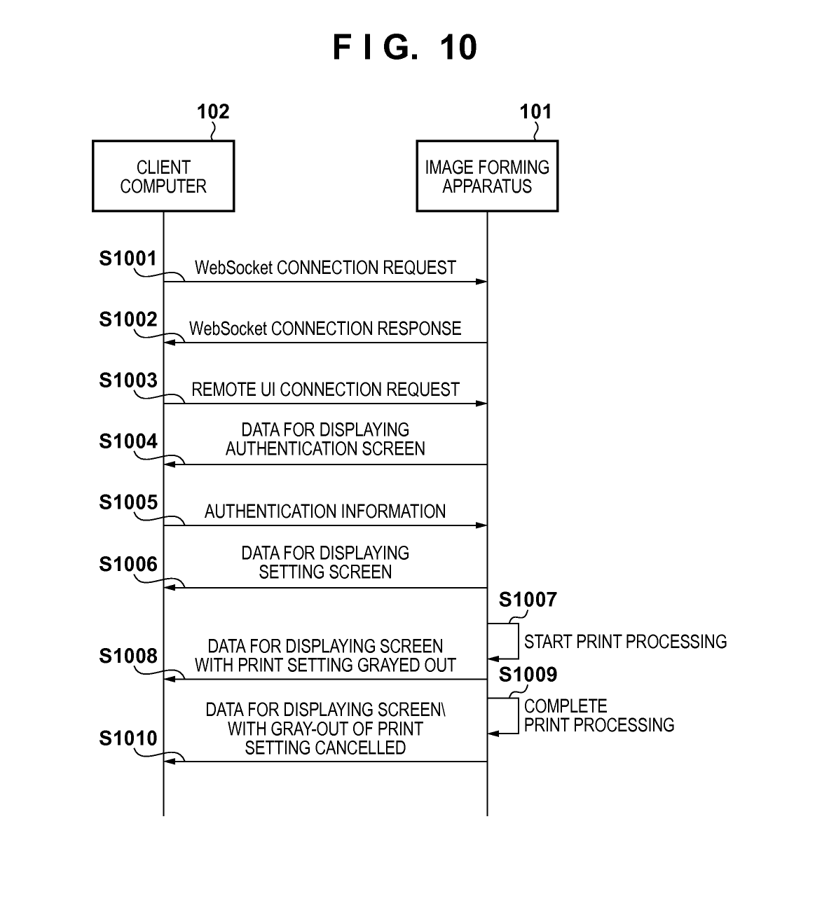

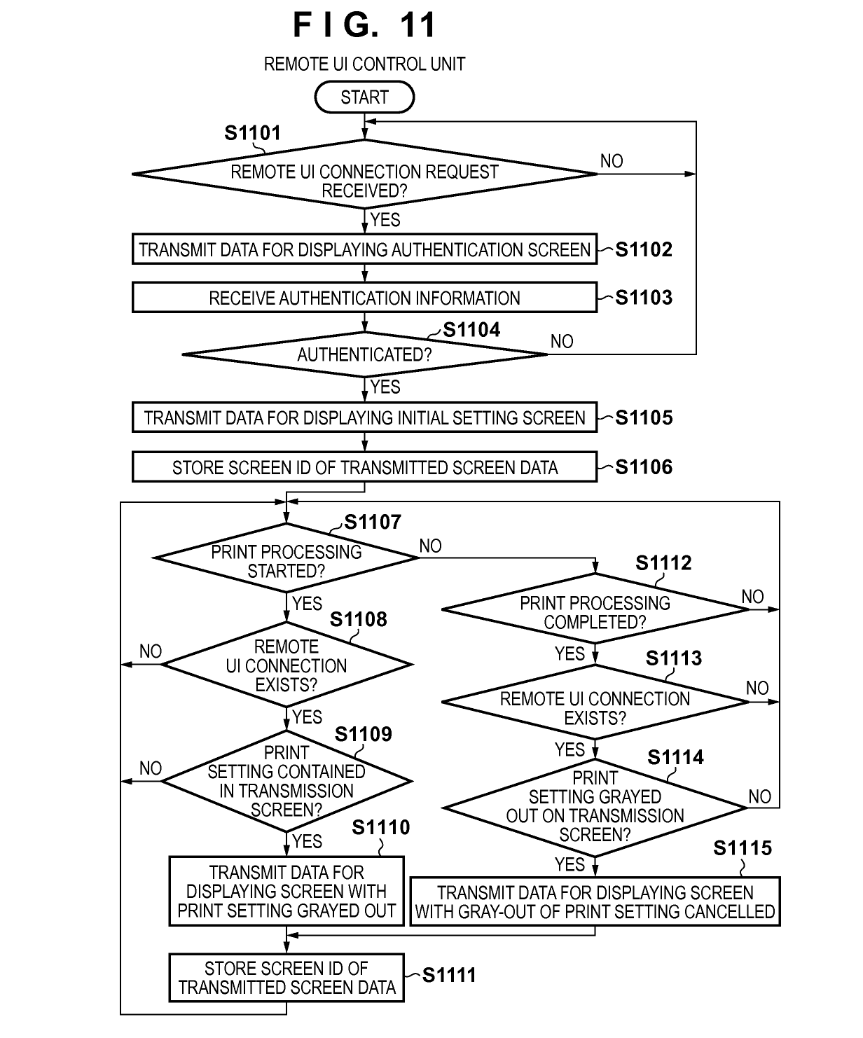

The image forming apparatus 101 according to this embodiment, when stating execution of a function of the image forming apparatus, transmits data for inhibiting input related to the function via a setting screen, to the client PC 102. Further, when completing execution of the function, the image forming apparatus 101 transmits data for cancelling the inhibition of input related to the function via the setting screen, to the client PC 102. FIG. 10 and FIG. 11 show an example in which a printing function is executed, out of the functions possessed by the image forming apparatus 101.

Example of Control of Remote UI in Communication System

FIG. 10 is a sequence diagram showing control procedures, which are executed by the image forming apparatus 101 and the client PC 102 in the communication system 100 according to this embodiment, for controlling the remote UI used to change the setting of the image forming apparatus 101. The processing of each step shown in FIG. 7 is performed in the image forming apparatus 101 by the CPU 201 loading a control program stored in the HDD 211 into the RAM 202 and executing the loaded program. Further, in the client PC 102, the processing of each step is performed by the CPU 301 loading a control program stored in the HDD 312 into the RAM 303 and executing the loaded control program.

First, the processing of steps S1001 to S1006 are the same as the processing of steps S701 to S706 in FIG. 7.

In step S1007, the image forming apparatus 101 starts execution of the print processing. Further, in step S1008, the image forming apparatus 101 transmits, to the client PC 102, screen data for displaying a screen on which a print-related setting is grayed out, in the same manner as in step S709.

Thereafter, upon completion of the execution of the print processing in step S1009, the image forming apparatus 101 transmits, to the client PC 102, screen data for displaying a screen on which the gray-out of the print-related setting is cancelled in step S1010, in the same manner as in step S711. The screen data transmitted to the client PC 102 by the image forming apparatus 101 in step S1010 is the same as the screen data transmitted in step S1006.

Although FIG. 10 shows the case where the printing function is executed in the image forming apparatus 101, the same processing may be performed, for example, in the case where a facsimile transmission function (FAX transmission function) is executed. Here, in step S1006, it is assumed that data for displaying a setting screen containing an address book-related setting (address setting) is transmitted. In this case, the image forming apparatus 101, for example, transmits screen data for displaying a setting screen on which an address book-related setting is grayed out (S1008), in response to the transition of the display of the operation panel 205 (local UI) to the FAX transmission screen (S1007).

Example of Processing in the Image Forming Apparatus 101

FIG. 11 is a flowchart showing processing procedures to be executed by the remote UI control unit 402 of the image forming apparatus 101. The processing of each step shown in the figure is performed in the image forming apparatus 101 by the CPU 201 of the image forming apparatus 101 loading a program stored in the HDD 211 into the RAM 202 and executing the loaded program.

First, the processes of steps S1101 to S1106 are the same as the processing of steps S801 to S806 in FIG. 8.

In step S1107, the remote UI control unit 402 determines whether or not the print processing has been started by the image forming apparatus 101 based on the notification from the print processing unit 404. If the print processing is determined to have been started, the processing proceeds to step S1108. If the print processing is determined not to have been started, the processing proceeds to step S1112. The processing of steps S1108 to S1111 is the same as the processing of steps S808 to S811 in FIG. 8.

In step S1112, the remote UI control unit 402 determines whether or not the print processing is completed based on the notification from the print processing unit 404. If the print processing is determined to have been completed, the processing proceeds to step S1113. If the print processing is determined not to have been completed, the processing returns to step S1107. The processing of steps S1113 to S1115 are the same as the processing of steps S813 to S815 in FIG. 8.

In this embodiment, when execution of a function (for example, the printing function) of the image forming apparatus 101 is started, the image forming apparatus 101 transmits data for inhibiting input related to the function via the setting screen to the client PC 102. It is thus possible to prevent a setting related to a function of the image forming apparatus 101 from being changed via the remote UI of the client PC 102 during the execution of the function, and thereby prevent unexpected execution results. Further, an unnecessary user operation can be prevented by inhibiting input via the setting screen of the client PC 102. Further, after the execution of the function of the image forming apparatus 101 is completed, the user can recognize with certainty the timing at which the setting change of the image forming apparatus 101 is enabled.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-237351, filed Nov. 15, 2013, which is hereby incorporated by reference herein in its entirety.

What is claimed is:

1. An image forming apparatus comprising:
a receiving unit configured to receive a connection request from a client computer;
an operation unit configured to receive an operation by an operator, the operation being an operation for changing a setting; and
a transmission unit configured to transmit, in a case where the operation is received, a notification to the client computer so as to inhibit change of the setting, and to transmit, after the change of the setting is completed, a notification to the client computer so as to permit an operation for changing the setting.

2. The image forming apparatus according to claim 1, wherein the setting is a print setting.

3. The image forming apparatus according to claim 1, wherein the operation by the operator is an operation to import a setting value of the image forming apparatus.

4. The image forming apparatus according to claim 1, wherein the transmission unit is further configured to transmit, to the client computer when execution of a function of the image forming apparatus is started, a notification to inhibit input related to the function via a setting screen displayed in the client computer, and to transmit, to the client computer when execution of the function is completed, a notification to cancel the inhibition of input related to the function via the setting screen.

5. The image forming apparatus according to claim 4, wherein the function is a printing function.

6. The image forming apparatus according to claim 4, wherein the function is a facsimile transmission function.

7. The image forming apparatus according to claim 1,
wherein the notification to inhibit change of the setting contains screen data for displaying a setting screen with input for an item related to the changed setting disabled, and
wherein the notification to permit the operation of changing the setting contains screen data for displaying the setting screen with input for the item related to the changed setting enabled.

8. The image forming apparatus according to claim 1,
wherein the notification to inhibit change of the setting is control data indicating to disable input for an item related to the changed setting, and
wherein the notification to permit the operation of changing the setting is control data indicating to enable input for the item related to the changed setting.

9. The image forming apparatus according to claim 1,
wherein the notification to inhibit change of the setting is data for displaying, in the client computer, information indicating that input for an item related to the changed setting is inhibited, and
wherein the notification to permit the operation of changing the setting is data for cancelling the displaying of the information based on the data for displaying the information.

10. The image forming apparatus according to claim 1, wherein the image forming apparatus communicates with the client computer via a connection established by WebSocket.

11. A method for controlling an image forming apparatus, comprising:
receiving a connection request from a client computer; and
transmitting, in a case where an operation, by an operator, for changing a setting is received, a notification to the client computer so as to inhibit change of the setting, and transmitting, after the change of the setting is completed, a notification to the client computer so as to permit an operation for changing the setting.

12. A non-transitory computer-readable storage medium storing a computer program for causing a computer to execute steps of a method for controlling an image forming apparatus, comprising:
receiving a connection request from a client computer; and
transmitting, in a case where an operation, by an operator, for changing a setting is received, a notification to the client computer so as to inhibit change of the setting, and transmitting, after the change of the setting is completed, a notification to the client computer so as to permit an operation for changing the setting.
